(19) United States
(12) Patent Application Publication
(10) Pub. No.: US 2011/0290550 A1
(43) Pub. Date: Dec. 1, 2011

(54) Electrical snap-in connector

(76) Inventor: Kenneth M. Kiely, Milford, CT (US)

(21) Appl. No.: 12/800,900

(22) Filed: May 25, 2010

(51) Int. Cl. H02B 1/40

(52) U.S. Cl. 174/480

(57) ABSTRACT

By providing an electrical connector which comprises a single component capable of being inserted into the knockout hole of a housing of any electrical junction box, outlet box, meter box, or similar enclosure from the interior of the housing and securely affixed thereto, an efficient, easily manufactured and installed electrical connector is achieved which can be securely mounted to the housing of any electrical junction box, outlet box, meter box, or similar enclosure from inside the housing. The electrical connector/clamp comprises a generally hollow cylindrical shape incorporating an axial, longitudinal extending slot formed therein which terminates along the length of the electrical clamp/connector and forms the cylindrical housing into two portions movable relative to each other. In this way, the electrical clamp/connector comprises a flexible construction enabling the electrical clamp/connector to flex and return to its original configuration, establishing a snap-in locking member, devoid of any lock nut.

### TECHNICAL FIELD

This invention relates to electrical connectors for metal clad or shielded cables and, more particularly, to electrical clamps or connectors constructed for enabling metal clad or shielded cables to be quickly and easily installed in the housing of an electrical service box, meter box, or other electrical enclosure from the interior of the housing.

### BACKGROUND ART

In the field of wiring homes and buildings, whether for new construction or for improvements or expansion, substantial development and product improvements have been made. Typically, these improvements are directed to enabling installers to securely and safely mount any desired wiring to any desired location in the most efficient and quickest manner.

In any particular installation or location, various conduits or cables must be interconnected to each other as well as connected to the primary power supply in a suitable power distributing outlet box, junction box, meter box, or other enclosure. In these instances, flexible metal conduit and/or armor or metal clad cables within which the electrical power carrying wires are contained, must be securely mounted to the housing of a junction box or outlet box, or connected to an appropriate solid or rigid metal tubing or conduit.

Although a wide variety of various products have been developed for securely affixing or mounting armor or metal clad cables directly to the housing of a junction box, outlet box, meter box, or other electrical enclosure, all of these prior art products are constructed for being securely affixed to the housing from an exterior surface of the housing. Typically, knockout holes are formed in the housings of the various electrical enclosures, with the electrical connectors being constructed for being inserted into the knockout holes and secured in place, typically by mounting a lock nut to a threaded end of the electrical connector with the lock nut being advanced and secured to the connector from an outside surface of the housing.

In many installations, access to the outside surface of an electrical housing or enclosure is not available, due to the positioning of the electrical enclosure and/or due to additions being made to existing structures. In these instances, the mounting of the armor or metal clad cable to the electrical enclosure is difficult, requiring extensive manual labor for achieving a secure mounted interengagement of the armor or metal clad cable to the housing. As a result, added costs are incurred as well as the inability to produce a standardized construction or configuration. Consequently, the need exists in the industry for the production of an electrical connector or clamp which eliminates this continuing problem.

Therefore, it is a principal object of the present invention to provide an electrical connector or clamp which is capable of being quickly and easily installed in the housing of any desired electrical junction box, outlet box, meter box, or similar enclosure from the interior of the housing.

Another object of the present invention is to provide an electrical connector or clamp having a characteristic features described above which completely eliminates any need for requiring access to the exterior surface of the housing of any desired electrical junction box, outlet box, meter box, or similar enclosure for securement or installation purposes.

Another object of the present invention is to provide an electrical connector or clamp having the characteristic features described above which is capable of being produced in a cost-effective manner from easily produced components.

Another object of the present invention is to provide an electrical connector or clamp having the characteristic features described above which is able to be mounted to an interior surface of the housing of any desired electrical junction box, outlet box, meter box, or similar enclosure, quickly and easily by a single individual.

Other and more specific objects will in part be obvious and will in part appear hereinafter.

### SUMMARY OF THE INVENTION

By employing the present invention, all of the difficulties and drawbacks of the prior art systems have been eliminated and an efficient, easily manufactured, and easily installed electrical connector or clamp is achieved which is able to be securely mounted to the housing of any desired electrical junction box, outlet box, meter box, or similar enclosure from inside the housing. In this way, the present invention eliminates the need for employing any type of lock nut or other securement system which requires access to an outside surface of the housing.

In accordance with the present invention, an electrical connector or clamp is constructed which comprises a single component which is capable of being inserted into the knockout hole of a housing of any electrical junction box, outlet box, meter box, or similar enclosure from the interior of the housing and securely affixed thereto. In this regard, the electrical connector/clamp comprises a generally hollow cylindrical shape incorporating an axial, longitudinal extending slot formed therein which terminates along the length of the electrical clamp/connector and forms the cylindrical housing into two portions which are movable relative to each other. In this way, the electrical clamp/connector comprises a flexible construction enabling the electrical clamp/connector to flex and return to its original configuration, effectively establishing a snap-in locking member, devoid of any lock nut.

In the preferred construction, the electrical connector/clamp also comprises a flange mounted to the outside surface thereof, with the flange radially extending axially outwardly from the outside surface. In addition, the overall diameter of the flange is constructed to be greater than the typical diameter employed for the knockout holes formed in the housings of electrical junction boxes, outlet boxes, and the like. As a result, the radially extending flange provides an abutment stop for the electrical connector/clamp of the present invention when the electrical connector/clamp is inserted into the knockout hole of the electrical enclosure.

In addition, the electrical connector/clamp of the present invention also incorporates an upstanding ridge or wall formed on the outer surface of the electrical connector/clamp which extends outwardly from the outside surface of the electrical connector/clamp and is positioned in juxtaposed, spaced relationship to the radially extending flange. In this regard, the upstanding ridge/wall comprises a diameter which is greater than the diameter of the knockout hole of the housing of the electrical enclosure and is spaced from the radially extending flange a distance greater than the wall thickness of the housing of the electrical enclosure.

As a result of this construction, the electrical connector/clamp is easily inserted into the knockout hole of the housing from the inside surface of the housing, resulting in the snap-in, automatic locking construction to be achieved. In this regard, the upstanding ridge/wall passes through the knockout hole, as the housing portions flex relative to each other, while the flange contacts and abuts the inside surface of the housing. In this way, the electrical clamp/connector of the present invention is securely mounted in the housing with the electrical clamp/connector being secured in position by the contact of the flange with the inside surface of the housing and the contact of the ridge/wall with the outside surface of the housing.

As discussed above, the hollow, cylindrically shaped component or member forming the electrical connector/clamp of the present invention incorporates an axially extending slot formed therein which longitudinally extends partially in the cylindrically shaped member to effectively define and establish two cooperating portions which are able to flex relative to each other. As a result, the electrical connector/clamp is advanced through the knockout hole of the housing by causing the two portions of the electrical clamp/connector to flex towards each other as the ridge/wall portions of the electrical connector/clamp are advanced through the knockout hole and then automatically returned to the original configuration once passage through the knockout hole has been completed.

In the preferred embodiment, in order to assist in assuring a trouble free insertion and advance of the electrical connector/clamp of the present invention into the knockout hole of the housing, the electrical clamp/connector of the present invention also incorporates a radially extending ramp element formed on a portion of the outside surface of the electrical connector/clamp which is positioned for cooperating association with the radially extending ridge/wall. In this regard, by employing a radially extending ramp element on the outside surface of the electrical connector/clamp, insertion ease and flexing of the electrical clamp/connector into the knockout hole of the housing is provided and trouble free, rapid, quickly installed result is attained. If desired, the ridge/wall may comprise a single member which substantially encircles the entire housing and may be formed as two or more separate components.

Finally, in accordance with the present invention, the electrical connector/clamp of the present invention also incorporates a locking screw which is threadedly mounted thereto and is employed for being threadedly advanced to securely affix and lockingly engage the armor or metal clad cable with the electrical connector/clamp. Typically, the armor or metal clad cable which is to be secured to the housing of the electrical junction box, outlet box, meter box, or other electrical enclosure is advanced into the interior of the housing using conventional techniques typically employed in the industry. However, due to the inability of the exterior surfaces of the housing to be accessible to the installer, normal mounted engagement of the armor or metal clad cable to the housing is not available.

By employing the present invention, the terminating end of the armor or metal clad cable is merely inserted through the knockout hole of the housing and then affixed to the electrical connector/clamp of the present invention, using the locking screw forming a part of the electrical connector/clamp. Then, the electrical connector/clamp, with the armor or metalclad cable affixed thereto is securely mounted to the housing from inside of the housing by merely pushing the electrical connector/clamp through the knockout hole of the housing. One secured in place, the electrical wires of the armor or metalclad cable extending through the electrical connector/clamp are employed in the desired manner for being connected to the appropriate locations within the housing of the electrical junction box, outlet box, meter box, or other electrical enclosure.

The invention accordingly comprises an article of manufacture possessing the features, properties, and the relation of elements which will be exemplified in the article hereinafter described, and the scope of the invention will be indicated in the claims.

### THE DRAWINGS

For a fuller understanding of the nature and objects of the invention, reference should be had to the following detailed description taken in connection with the accompanying drawings, in which:

FIG. 1 is a perspective view of the electrical connector/clamp of the present invention;

FIG. 2 is a front elevation view of the electrical connector/clamp of FIG. 1;

FIG. 3 is a rear elevation view of the electrical connector/clamp of FIG. 1;

FIG. 4 is a side elevation view of the electrical connector/clamp of FIG. 1;

FIG. 5A is a side elevation view of the electrical connector/clamp of FIG. 1 in the process of being inserted through an aperture;

FIG. 5B is a side elevation view of the electrical connector/clamp of FIG. 1 shown with an armor or metal clad cable inserted therein and mounted in position;

FIG. 6 is a top view of the electrical connector/clamp of FIGS. 1;

FIG. 7 is a bottom view of the electrical connector/clamp of FIG. 1;

FIG. 8 is a perspective view of an alternate embodiment of the electrical connector/clamp of the present invention;

FIG. 9 is a side elevation view of a further alternate embodiment of the electrical connector/clamp of the present invention; and

FIG. 10 is a cross-sectional side elevation view depicting the electrical connector/clamp of FIG. 1 securely mounted in a housing of an electrical enclosure.

### DETAILED DESCRIPTION

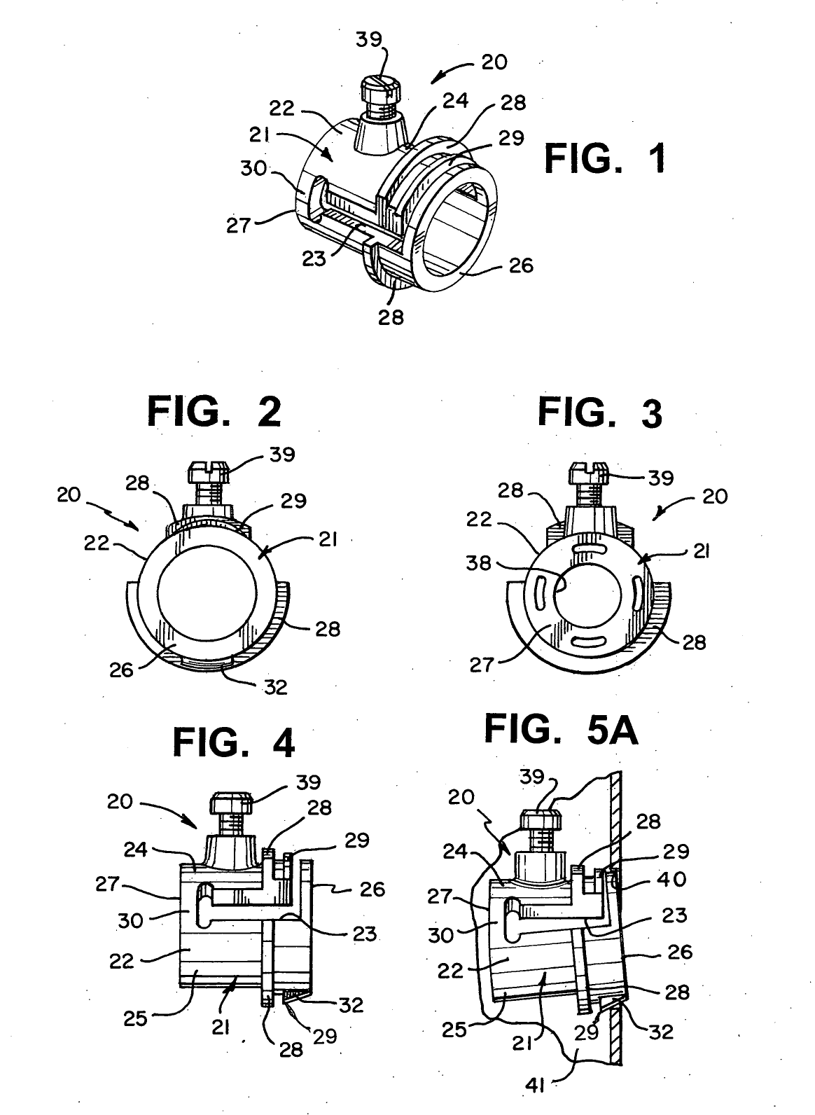

By referring By referring to FIGS. 1-10, along with the following detailed disclosure, the construction and operation of three preferred alternate embodiments of the electrical connector/clamp of the present invention can best be understood. Although the following disclosure fully details each of the three alternate embodiments and presents the best mode for implementing the present invention, the electrical connector/clamp of the present invention can be constructed in further alternate configurations. Consequently, it is to be understood that the embodiments detailed herein are provided for exemplary purposes only and are not intended as a limitation of the present invention.

By referring to FIGS. 1-7, along with the following detailed disclosure, the construction and operation of one preferred embodiment of electrical connector/clamp 20 of the present invention can best be understood. As clearly depicted in these figures, electrical connector/clamp 20 comprises a generally hollow, cylindrically shaped member 21 incorporating outer surface 22, front end 26 and rear end 27. Furthermore, cylindrically shaped member 21 incorporates axial, longitudinally extending slot 23 formed therein extending a major portion of the length of member 21, effectively establishing separate housing portions 24 and 25.

In addition, electrical clamp/connector 20 incorporates flange 28 radially extending outwardly from surface 22 of hollow, cylindrically shaped member 21. In the preferred construction, flange 28 substantially encircles surface 22 of clamp/connector 20 and comprises a diameter greater than the typical diameter employed for the knockout holes formed in the housings of conventional outlet boxes, meter boxes, junction boxes, and other similar electrical enclosures. By employing this construction, flange 28 forms a positive abutment stop for electrical clamp/connector 20 whenever clamp/connector 20 is inserted into the knockout hole of a desired electrical housing.

In order to provide the desired automatic, snap-in, locked interengagement of electrical clamp/connector 20 in any desired electrical housing, electrical clamp/connector 20 also comprises ridge or wall 29 radially extending outwardly from surface 22 of member 21, with ridge/wall 29 positioned in juxtaposed, spaced, cooperating relationship with flange 28. In the preferred embodiment, ridge/wall 29 also comprises an overall diameter which is greater than the diameter typically employed in the knockout hole of the electrical housing. However, as is more fully detailed below, electrical clamp/connector 20 is constructed with portions 24 and 25 of member 21 being flexible relative to each other, thereby enabling ridge/wall 29 to be deflected for enabling electrical clamp/connector 20 to be inserted through the knockout hole, and then return to its original position, securely affixing electrical clamp/connector 20 in the desired housing.

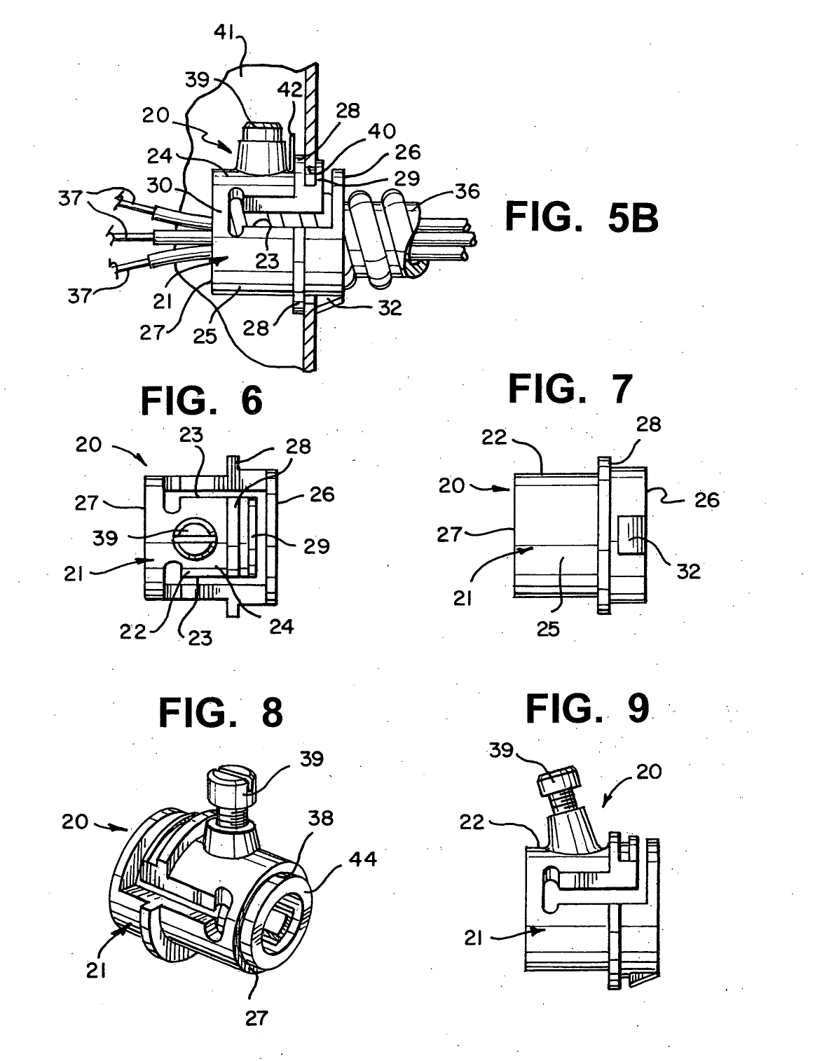

As the best seen in FIGS. 4, 5A and 5B, longitudinally extending slot 23 formed in member 21 is constructed to effectively establish separate housing portions 24 and 25 which are interconnected to each other at terminating zone 30 formed at the terminating end of slot 23. As a result, housing portions 24 and 25 are capable of flexing relative to each other, while still being securely affixed and attached to each other.

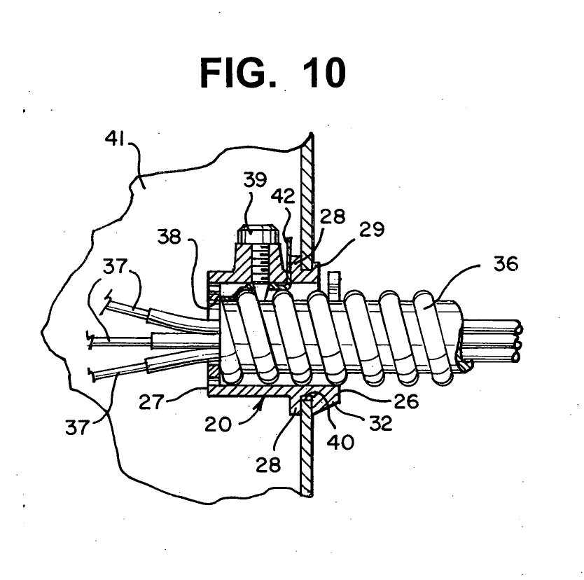

By constructing slot 23 to extend through a major length of member 21, while terminating in member 21 with terminating zone 30, portions 24 and 25 are interconnected to each other and are able to be advanced or flexed towards each other, while still retaining sufficient inherent spring force to automatically return to their original positions. In this way, as shown in FIGS. 5A, 5B, and FIG. 10, ridge/wall 29 is able to be deflected for allowing electrical clamp/connector 20 to be inserted through knockout hole 40 of electrical housing 41.

In order to assure that electrical clamp/connector 20 is easily and quickly inserted into knockout hole 40 of a desired housing 41 and securely retained therein, electrical clamp/connector 20 incorporates sloping, ramp 32 formed on outer surface 22 and extending from front end 26, terminating with ridge/wall 29. In this way, whenever electrical clamp/connector 20 is inserted into knockout hole 41, ramp 32 contacts the edge of knockout hole 40, causing portion 25 of member 21 to be flexed towards portion 24 of member 21.

In addition, during the insertion process, the installer would press portion 24 towards portion 25, for assisting in the deflection of ridge/wall 29. As a result, electrical clamp/connector 20 is able to be quickly inserted through knockout hole 40 and subsequently returned to its original position with ridge/wall 29 lockingly engaging the outside surface of the housing 41.

In a typical installation, prior to lockingly engaging electrical clamp/connector 20 in housing 41, the desired armored or metal clad cable 36 is mounted with electrical clamp/connector 20. In order to achieve this mounting operation, electrical clamp/connector 20 is longitudinally advanced onto the terminating end of armored or metal clad cable 36, with electrical wires 37 contained in cable 36 telescopically advanced through aperture 38 of rear end 27, for enabling wires 37 to be employed in the desired manner.

In the preferred construction, rear end 27 of electrical clamp/connector 20 comprises a terminating end wall with aperture 38 formed therein. In this way, the end of armored or metal clad cable 36 is advanced into contact with the end wall of rear end 27 and, once in its final position, locking screw 39 is rotated into locking engagement with the outer surface of armored or metal clad cable 36. In this way, cable 36 is securely affixed with electrical clamp/connector 20.

As is evident from the foregoing detailed disclosure, armor or metal clad cable 36 is quickly and easily secured to electrical clamp/connector 20 with electrical wires 37 extending through clamp/connector 20. As discussed above, armor or metal clad cable 36 is advanced through knockout hole 40 of housing 41 in order to position the terminating end of cable 36 inside housing 41. Then, electrical clamp/connector 20 is secured to cable 36 for final installation.

In order to complete the installation process, electrical clamp/connector 20 is inserted through knockout hole 40 of electrical enclosure 41 from inside housing 41 in the manner fully detailed above. Once this quick and easy, snap in engagement is completed, the desired installation of cable 36 in electrical housing 41 is completed. In addition, as shown in FIG. 10, securement screw 39 which is advanced into secure clamping engagement with the outer surface of the armor or metal clad cable 36, is a preferably connected to grounding plate 42 which provides the desired electrical grounding of armor or metal clad cable 36 with housing 41.

By employing the present invention, the complete securement and installation of cable 36 with electrical clamp/connector 20 in housing 41 is completed in a rapid and easily installed manner. In addition, as is evident from the foregoing detailed disclosure, the complete installation process is achieved from the interior of housing 41, including the securement of electrical clamp/connector 20 to housing 41. As a result, the installer is able to avoid any need for accessing the exterior surface of housing 41 during the installation process, thereby eliminating the cumbersome and difficult task frequently required of installers using prior art systems.

As clearly shown in the drawings of the present invention, electrical clamp/connector 20 is constructed with elongated slot 23 terminating prior to reaching front end 26. In this preferred construction, elongated slot 23 preferably comprises an L-shape, terminating with outside surface 22 of cylindrically shaped member 21.

In this way, front end 26 comprises a complete, continuous, circular shape, and is not split into two separate and independent segments. It has been found that a complete circular segment possesses enhanced structural integrity and is preferred. However, although the embodiment depicted in the drawings is preferred, alternate constructions can be employed, including extending the elongated slot 23 through to front end 26, if desired.

In FIGS. 8 and 9, two alternate embodiments of electrical clamp/connector 20 are depicted. In these alternate embodiments, the construction of clamp/connector 20 is virtually identical to the construction of claim/connector 20 detailed above and shown in FIGS. 1-7. Consequently, the foregoing detailed discussion and disclosure is incorporated herein by reference, and the similar or identical elements shown in FIGS. 8 and 9 are displayed using identical reference numerals.

In the embodiment depicted in FIG. 8, the principal distinguishing feature incorporated therein comprises plastic sleeve 44 which is inserted in aperture 38 of rear end 27. Although sleeve 44 is not required, it has been found that in many instances the incorporation and use of plastic sleeve 44 is desirable, since it provides a nonabrasive corner or edge over which wires 37 extend. As a result, undesirable chafing or abrasion of the outer surface of wires 37 is virtually eliminated.

In FIG. 9, a further alternate embodiment of electrical clamp/connector 20 is depicted. In this embodiment, screw 39 is mounted in a receiving post which extends from the outer surface 22 of cylindrically shaped member 21 at an angle relative thereto, as opposed to the substantially perpendicular post employed in the previous embodiment. Although either screw receiving post configuration can be employed with equal efficacy, in some instances, the angular position for screw receiving post is desirable for enabling screw 39 to be advanced into clamping engagement with the other surface of armor or metal clad cable 36 at an angle relative thereto, as opposed to contacting cable 36 substantially perpendicularly.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of a language, might be said to fall therebetween.

Having described my invention, what I claim as new and desire to secure by Letters Patent is:

1. An electrical connector for securely engaging and mounting an electrical cable to the interior of a junction box, meter box, or electrical enclosure having in an aperture formed therein, said of electrical connector comprising:
A. a housing having a generally hollow cylindrical shape defined by an outer wall and an inner wall and being dimensioned for enabling an electrical cable to be telescopically inserted therein in cooperating relationship with the inner wall of said box/enclosure;
B. at least one flange mounted about the outer wall of the housing, radially extending outwardly therefrom, and comprising a diameter greater than the diameter of the aperture formed in the junction box/electrical enclosure;
C. two axial, longitudinally extending slots formed in the housing in cooperating relationship to each other, and constructed for establishing a flexible wall portion comprising a minor section of the housing capable of pivoting movement relative to the remaining major portion thereof;
D. a locking ridge mounted to the outer wall of the housing and radially extending outwardly therefrom and comprising a diameter greater than the diameter of the aperture formed in the junction box/electrical enclosure, and positioned in juxtaposed, spaced, cooperating relationship with the radially extending flange, forming a gap therebetween substantially equivalent to the thickness of the junction box/enclosure; and
E. clamping means threadedly engaged with the housing for enabling an electrical cable to be securely affixed to the housing when desired;
whereby the electrical connector is quickly and easily secured to any desired electrical cable and subsequently securely mounted to a junction box or electrical enclosure from the interior thereof by merely telescopically advancing the electrical connector through an aperture formed in the junction box or electrical enclosure until the locking tab passes through the aperture and the radially extending flange abuts the inner surface of the junction box or electrical enclosure.

2. The electrical connector defined in claim 1, and further comprising:
F a ramped, sloping surface mounted to the outer wall of the major portion of the housing directly adjacent a leading edge thereof, and extending from said leading edge to the locking ridge, thereby forming a surface for assisting in the telescopic advance of the electrical connector through the aperture of the box/enclosure.

3. The electrical connector defined in claim 2, wherein each of said axial, longitudinally extending slots are further defined as having at least one terminating end formed in the housing.

4. The electrical connector defined in claim 3, wherein said connector is further defined as comprising a third slot formed therein, inwardly of the leading edge of the housing and extending substantially perpendicularly to, and interconnected with, the two longitudinally extending slots, thereby defining the edge of said minor portion.

5. The electrical connector defined in claim 4, wherein the flexible wall portion comprising the minor section of the housing is capable of moving inwardly towards the major portion thereof, enabling the connector with its radially extending locking ridge to pass through the aperture of the junction box/electrical enclosure and return to its original position with the radially extending locking ridge in abutting contact with the outside wall of the junction box/electrical enclosure.

6. The electrical connector defined in claim 5, wherein the ramped sloping surface formed on the major portion of the housing contacts the edge of the aperture formed in the junction box/electrical enclosure as the connector is advanced through said aperture, assisting and causing the major portion and minor portion of the housing of said connector to be compressed towards each other for insertion through the aperture of the junction box/electrical enclosure.

7. The electrical connector defined in claim 1, wherein said clamping means is further defined as comprising a screw member threadedly mounted to the housing for being advanced into clamping engagement with an electrical cable inserted into the housing.

8. The electrical connector defined in claim 7, wherein said housing further comprises a mounting post formed thereon for receiving the screw member.

9. The electrical connector defined in claim 8, wherein said mounting post is further defined as being formed on the outer wall of the housing, extending substantially perpendicularly therefrom.

10. The electrical connector defined in claim 8, wherein said mounting post is further defined as being formed on the outer wall of the housing, extending at an acute angle therefrom.

11. The electrical connector defined in claim 1, wherein said electrical connector further comprises a plastic sleeve mounted in one terminating end of said housing for reducing abrasive, frictional contact between the housing and wires contained in the electrical cable.

12. The electrical connector defined in claim 1, wherein said housing further comprises a grounding plate mounted therein and positioned for providing a grounding path between the electrical cable in the junction box/electrical enclosure.
